(19) United States
(12) Patent Application Publication
(10) Pub. No.: US 2006/0138998 A1
(43) Pub. Date: Jun. 29, 2006

(54) Battery charger

(75) Inventors: Yun-Lung Chen, Tu-Cheng (TW); Pei-Bin Luo, Shenzhen (CN); Ming-Xian Sun, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/238,861

(22) Filed: Sep. 28, 2005

(30) Foreign Application Priority Data
Dec. 24, 2004 (CN) 200420103475.5

(51) Int. Cl. H02J 7/00

(52) U.S. Cl. 320/107

(57) ABSTRACT

A battery charger includes a base body (10) and an adaptor member (30, 50). The base body defines a recess (12) therein. A plurality of terminals (153, 163) is formed in the recess. The adaptor member is secured into the recess of the base body for accommodating a battery. The adaptor member defines an opening (322, 560) for the terminals extending therethrough to come in contact with terminals of the battery.

### BACKGROUND OF THE INVENTION

1. Field of the Invention

The present invention relates to battery chargers, and more particularly to a battery charger of 3C (computer, communication, consumer electronics) products such as a mobile telephone, a PDA, a digital camera, a digital video camera, etc.

2. Description of Background

Various types of 3C (computer, communication, consumer electronics) products, such as a mobile telephone, a PDA, a digital camera, a digital video camera, etc., are used today. Each type of 3C products has a special battery and a corresponding battery charger.

For example, a conventional battery charger includes a body, a circuit board within the body, a reel assembly within in the body, an retractable outlet lead wire, a rotable reel, a securing axle, a slide switch, and a two-pinned plug. The outlet lead wire is configured in the reel assembly and extendable outside the body. A terminal is formed at an end of the outlet lead wire for connection directly into a jack of a mobile phone. The reel is positioned at a side of the reel assembly. The securing axle is positioned at a side of the reel to facilitate threading of the outlet lead wire through a gap which is defined between the reel axle and the securing axle. The slide switch is positioned at a side of the body. A catch is provided on an inner edge of the slide switch for catching hold of the outlet lead wire. One end of the catch is engaged with a spring. The plug is positioned at one end of the body for engaging the circuit board within the body of the battery charger. A battery recess is defined in the body for holding a mobile phone battery therein. A plurality of flexible terminals is formed in the battery recess. The terminals of the body engage with the circuit board and come in contact with terminals of the mobile phone battery, thereby charging the mobile phone battery. However, the battery charger can only charge batteries of one type of mobile phone. That is inconvenient to the user to charge batteries of various types of mobile telephones.

What is desired, therefore, is a battery charger which is adapt to charging batteries of various types of 3C products.

### SUMMARY

A battery charger includes a base body and an adaptor member. The base body defines a recess therein. A plurality of terminals is formed in the recess. The adaptor member is secured into the recess of the base body for accommodating a battery. The adaptor member defines an opening for the terminals extending therethrough to come in contact with terminals of the battery.

Advantages and novel features of the present invention will be drawn from the following detailed description of preferred embodiment with attached drawings, in which:

### BRIEF DESCRIPTION OF THE DRAWINGS

FIG. 1 is an exploded, isometric view of a battery charger of a preferred embodiment of the present invention, the battery charger including a base body and a first adaptor member;

FIG. 2 is similar to FIG. 1, but showing in another view;

FIG. 3 is an isometric view of the base body;

FIG. 4 is an assembled view of FIG. 1;

FIG. 5 is an isometric view of a second adaptor member of the battery charger of the present invention;

FIG. 6 is similar to FIG. 5, but showing in another view; and

FIG. 7 is an assembled view of the second adaptor member and the base body.

### DETAIL DESCRIPTION OF PREFERRED EMBODIMENT

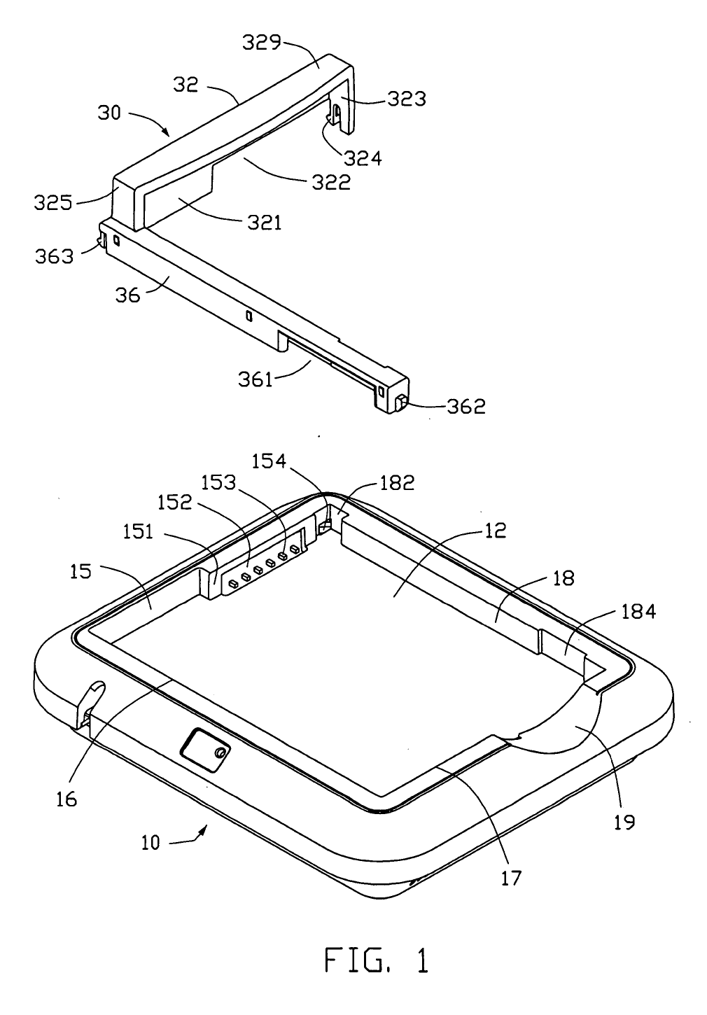

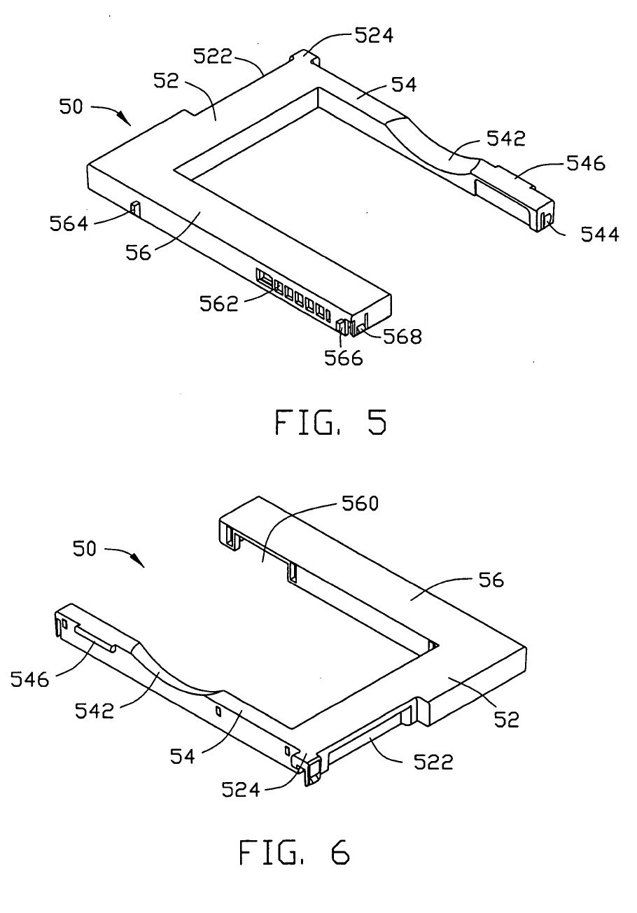

Referring to FIGS. 1 and 5, a battery charger of 3C (computer, communication, consumer electronics) products, such as a mobile telephone, a PDA, a digital camera, a digital video camera, etc, in accordance with a preferred embodiment of the present invention includes a base body 10, a first adaptor member 30 and a second adaptor member 50.

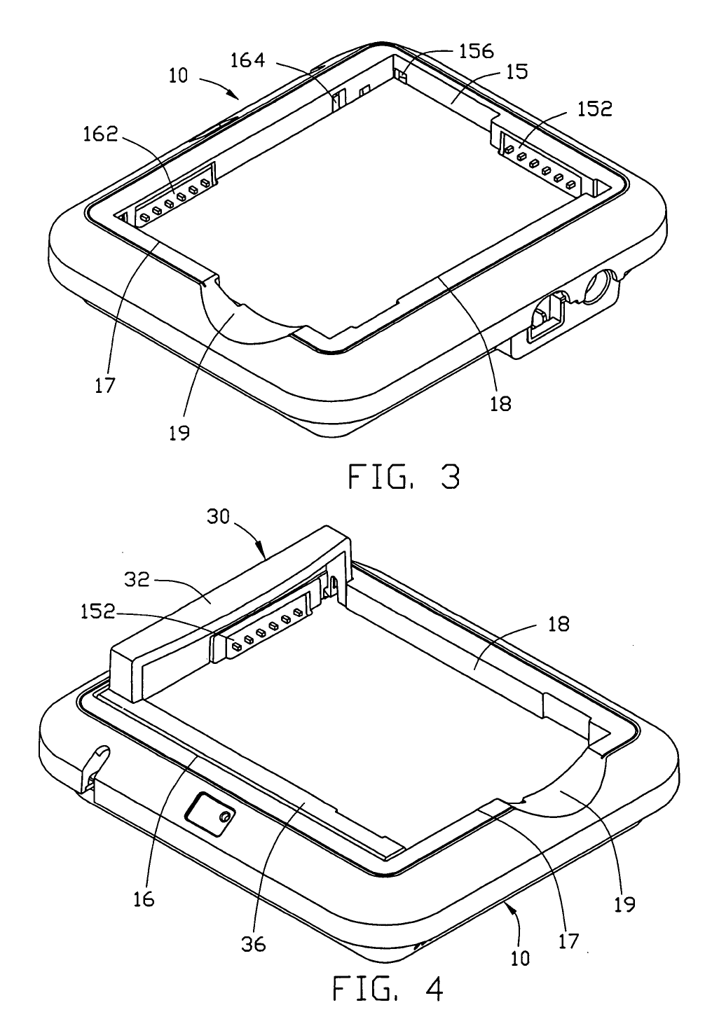

Referring to FIGS. 1 to 3, the base body 10 defines a recess 12 therein. The recess 12 has a first sidewall 15, a second sidewall 16, a third sidewall 17 and a fourth sidewall 18. The first sidewall 15 forms a protrusion 151 adjacent to the fourth sidewall 18. A socket 152, having a plurality of terminals 153 for coming in contact with terminals of batteries, is formed on the protrusion 151. Apair of securing holes 154, 156 is defined in both ends of the first sidewall 15. The second sidewall 16 also has a socket 162 with a plurality of terminals 163. Two locking holes 164, 166 are defined in both sides of the socket 162 of the second sidewall 16. The third sidewall 17 defines a pair of positioning holes 174, 176 adjacent to the second sidewall 16 and the fourth sidewall 18 respectively. A step 182 is formed at an end of the fourth sidewall 18 adjacent to the first sidewall 15. A groove 184 is defined in the other end thereof. An arc-shaped entry 19 is defined in the base body 10 near the third sidewall 17 for conveniently disengaging battery from the charger.

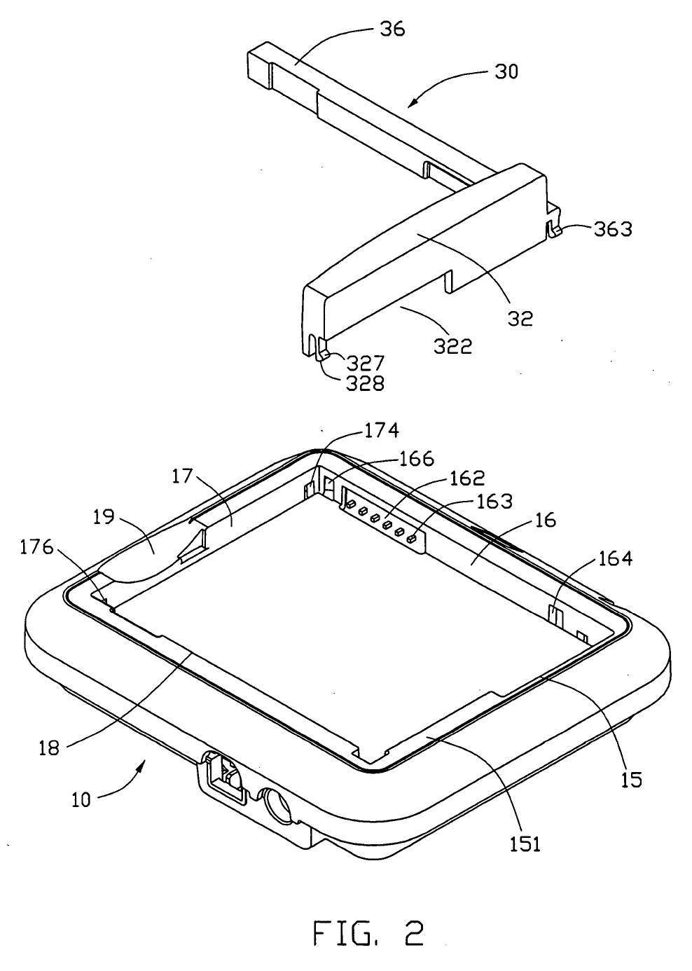

The first adaptor member 30 is adapted for installing a first type of battery into the recess 12 of the base body 10. The first type of battery has a plurality of terminals. The first adaptor member 30 has a first arm 32 and a second arm 36 perpendicular to the first arm 32. The first arm 32 includes a front wall 321, a pair of sidewalls 323, 325 and a top wall 329. The first arm 32 defines an opening 322 in the front wall 321 thereof, for the terminals 153 of the base body 10 extending therethrough. A flexible hook 324 is formed at a bottom portion of the sidewall 323 corresponding to the securing hole 154 of the first sidewall 15. The hook 324 has two slanted surfaces 327, 328 at an end portion. The slanted surface 327 extends outwardly and downwardly, and the slanted surface 328 extends outwardly and upward, shown in FIG. 2. One end of the second arm 36 is perpendicularly connected with one end of the first arm 32 thereunder. A cutout 361 is defined in the second arm 36 corresponding to the socket 162 of the second sidewall 16. A positioning block 362 protrudes from the free end of the second arm 36 corresponding to the positioning hole 174 of third sidewall 17, and a hook 363 is formed at the opposite end thereof. The hook 363 is similar to the hook 324.

Referring also to FIGS. 5 and 6, the second adaptor member 50 is adapted for installing a second type of battery into the recess 12 of the base body 10. The second type of battery has different sizes from the first type of battery, and also has a plurality of terminals. The second adaptor member 50 includes a first arm 52, a second arm 54 and a third arm 56. The second and third arms 54, 56 are perpendicularly bent from opposite ends of the first arm 52. A cutout 522 is defined in the first arm 52 corresponding to the socket 152 of the base body 10. A securing block 524 is formed at a corner of the second adaptor member 50, for engaging with the step 182 of the base body 10. The second arm 54 defines an arc-shaped entry 542 for conveniently disengaging batteries from the charger. A flexible hook 544 protrudes from the free end of the second arm 54. A positioning protrusion 546 is formed along an outer edge of the second arm 54, between the entry 542 and the hook 544. An opening 560 is defined in the third arm 56, and a plurality of through holes 562 is defined in communication with the opening 560 thereof corresponding to the terminals 163 of the base body 10. A pair of positioning blocks 564 protrudes from a side of the third arm 56, corresponding to the locking holes 164 of the second sidewall 16. A flexible hook 568 protrudes from the free end of the third arm 56. The hooks 544, 568 are similar to the hooks 324, 363 of the first adaptor member 30.

Referring also to FIG. 4, in assembling the first adaptor member 30 to the recess 12 of the base body 10, the positioning block 362 of the second arm 36 is inserted into the positioning hole 174 of the third sidewall 17 of the base body 10. The first arm 32 is deflected downwardly. The protrusion 151 of the first sidewall 15 engages into the opening 322 of the first arm 32. The terminals 153 are accessible to the first type of battery. The sidewall 323 of the first arm 32 engages with the step 182 of the recess 12, and the hooks 324, 363 are respectively locked into the securing holes 154, 156 of the first sidewall 15. The terminals 163 of the socket 162 are received in the cutout 361 and separated from the first type of battery. The first adaptor member 30 is thus secured into the recess 12 of the base body 10.

In disassembling the first adaptor member 30 from the recess 12 of the base body 10, the first arm 32 is pulled upwardly to disengage the hooks 324, 363 from the securing holes 154, 156 of the first sidewall 15. Thus, the first adaptor member 30 can be taken out from the recess 12 of the base body 10.

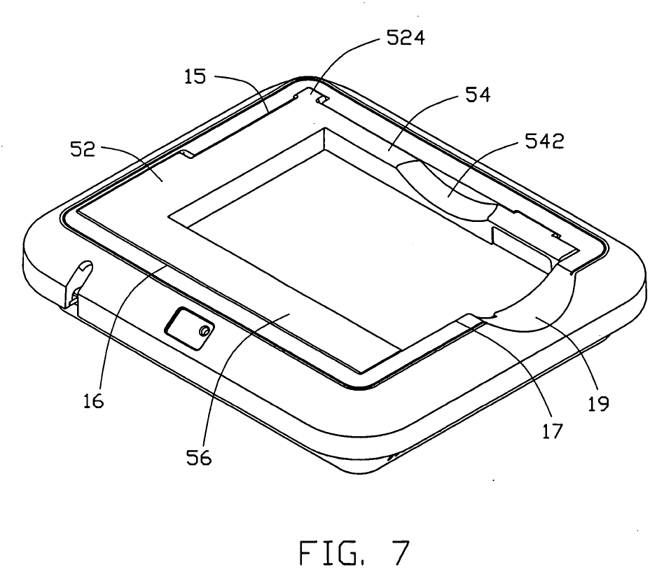

Referring also to FIG. 7, in assembling the second adaptor member 50 to the base body 10, the positioning blocks 564, 566 are inserted into the locking holes 164, 166 of the second sidewall 16. The terminals 163 of the socket 162 extend through the opening 560 via the through holes 562 of the third arm 56, for accessible to the second type of battery. The second arm 54 is deflected downwardly. The protrusion 151 engages in the cutout 522 of the first arm 52. The terminals 153 are received in the cutout 522 and separated from the second type of battery. The securing block 524 is secured into the step 182 of the fourth sidewall 18. The positioning protrusion 546 inserts into the groove 184. The hooks 544, 568 of the second and third arms 54, 56 are locked into the securing holes 154, 156 of the first sidewall 15 of the recess 12 respectively.

In disassembling the second adaptor member 50 from the recess 12 of the base body 10, the second arm 54 is pulled upwardly to disengage the hooks 544, 568 from the securing holes 154, 156. Thus the second adaptor member 50 can be taken out from the recess 12 of the base body 10.

In use, when the first type of battery is desired to charge, the first adaptor member 30 is installed to the base body 10. The first type of battery including its connection portion is then received in the base body 10, and the terminals of the connection portion of the first type of battery come in contact with the terminals 153 of the base body 10. When the second type of battery is desired to charge, the second adaptor member 50 replaces the first adaptor member 30 to install into recess 12 of the base body 10. The second type of battery including its connection portion is then received in the base body 10, and the terminals of the connection portion of the second type of battery come in contact with the terminals 153 of the base body 10.

It is to be understood, however, that even though numerous characteristics and advantages have been set forth in the foregoing description of preferred embodiments, together with details of the structure and function, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A battery charger comprising:
a base body having a recess, a plurality of terminals being formed in the recess; and
an adaptor member secured into the recess of the base body for accommodating a battery, the adaptor member defining an opening for the terminals extending therethrough to come in contact with terminals of the battery.

2. The battery charger as described in claim 1, wherein at least one hook is formed at the adaptor member, and at least one securing hole is defined in the recess for receiving the at least one hook.

3. The battery charger as described in claim 2, wherein each of the hooks has two slanted surfaces, one slanted surface extending outwardly and downwardly, and the other slanted surface extending outwardly and upward.

4. The battery charger as described in claim 3, wherein the adaptor member is adapted to accommodating a first type of battery into the recess, and has a first arm and a second arm perpendicular to the first arm.

5. The battery charger as described in claim 4, wherein the opening is defined in the first arm, and the at least one hook is formed at the first arm.

6. The battery charger as described in claim 4, wherein at least one positioning block protrudes from an free end of the second arm of the adaptor member, and at least one positioning hole is defined in a sidewall of the recess of the base body for receiving the at least one positioning block.

7. The battery charger as described in claim 3, wherein the adaptor member is adapted to installing a second type of battery into the recess, and has a first arm, second and third arms perpendicular to the first arm.

8. The battery charger as described in claim 7, wherein the opening is defined in the first second arm, and the at least one hook is formed at the first arm.

9. The battery charger as described in claim 8, wherein at least one positioning block protrudes from an free end of one of the second and third arms, and at least one positioning hole is defined in a sidewall of the recess of the base body for receiving the at least one positioning block.

10. A battery charger comprising:
a base body having a recess, at least two socket being formed in the recess, each socket having a plurality of terminals; and
at least two adaptor members securing into the recess of the base body for accommodating first and second type of batteries respectively, each of the adaptor members defining an opening for the terminals of one socket extending therethrough to come in contact with terminals of the battery, and a cutout for receiving the terminals of the other socket to separate from the terminals of the battery.

11. The battery charger as described in claim 10, wherein at least one hook is formed at the at least one adaptor member, and at least one securing hole is defined in the recess for receiving the at least one hook.

12. The battery charger as described in claim 11, wherein each of the hooks has two slanted surfaces, one slanted surface extending outwardly and downwardly, and the other slanted surface extending outwardly and upward.

13. The battery charger as described in claim 12, wherein one of the at least one adaptor member is adapted to installing a first type of battery into the recess, and has a first arm and a second arm perpendicular to the first arm.

14. The battery charger as described in claim 13, wherein the opening is defined in the first arm, and the at least one hook is formed at the first arm.

15. The battery charger as described in claim 13, wherein at least one positioning block protrudes from an free end of the second arm of the adaptor member, and at least one positioning hole is defined in a sidewall of the recess of the base body for receiving the at least one positioning block.

16. The battery charger as described in claim 12, wherein one of the at least one adaptor member is adapted to installing a second type of battery into the recess, and has a first arm, second and third arms perpendicular to the first arm.

17. The battery charger as described in claim 16, wherein at least one positioning block protrudes from an free end of one of the second and third arms, and at least one positioning hole is defined in a sidewall of the recess of the base body for receiving the at least one positioning block.

18. A battery charger comprising:
a base body defining a recess therein and exposing said recess from a side thereof, a socket defined in said recess being reachable from said side of said base body;
an adaptor member capable of being installed in said recess in order for reshaping said recess so as to allow a connection portion of a predetermined battery accommodated in said reshaped recess and further electrically connectable with said socket in said recess.

19. The battery charger as described in claim 18, further comprising another adaptor member capable of being installed in said recess in order for reshaping said recess so as to allow a connection portion of a battery of another kind different from said predetermined battery accommodated in said reshaped recess and further electrically connected with another socket defined in said recess.
